(19) United States
(12) Patent Application Publication
(10) Pub. No.: US 2025/0093143 A1
(43) Pub. Date: Mar. 20, 2025

(54) SHAPE MEASUREMENT METHOD AND SHAPE MEASUREMENT DEVICE

(71) Applicant: Panasonic Intellectual Property Management Co., Ltd., Osaka (JP)

(72) Inventor: TATSUYA SAKUMA, Osaka (JP)

(21) Appl. No.: 18/964,750

(22) Filed: Dec. 2, 2024

Related U.S. Application Data
(63) Continuation of application No. PCT/JP2023/011231, filed on Mar. 22, 2023.

(30) Foreign Application Priority Data
Jun. 14, 2022 (JP) 2022-095906

(51) Int. Cl. G01B 5/20; G01B 5/012

(52) U.S. Cl. CPC G01B 5/20; G01B 5/012; G01B 2210/52

(57) ABSTRACT

A shape measurement method of the present disclosure is configured to measure a three-dimensional shape of a surface of a measurement object, the shape measuring method including the steps of: dividing the surface of the measurement object into a plurality of measurement regions; acquiring a plurality of sets of partial measurement data; calculating a first coordinate transformation parameter for performing global alignment of the plurality of sets of partial measurement data; acquiring error calculation data including a normal line at each of a plurality of measurement points of the plurality of sets of partial measurement data; extracting an overlapping region based on the plurality of sets of partial measurement data and the first coordinate transformation parameter; calculating a second coordinate transformation parameter for performing local alignment of the plurality of sets of partial measurement data based on the error calculation data in the extracted overlapping region; and generating composite data by combining the plurality of sets of partial measurement data based on the first coordinate transformation parameter and the second coordinate transformation parameter.

### TECHNICAL FIELD

The present disclosure relates to a shape measurement method and a shape measurement device.

### BACKGROUND ART

As a device for measuring a three-dimensional shape of an optical component such as a lens with high accuracy on the order of nanometers, a contact type or non-contact type three-dimensional measuring machine has been developed. The three-dimensional measuring machine includes devices for each of which a range of measurable sizes and inclination angles is determined. When a three-dimensional shape of an optical component having a size exceeding the measurable range is measured, a method is used in which a surface of the optical component is measured multiple times by being divided into a plurality of regions, and each measurement data is synthesized after the measurement.

For example, PTL 1 describes a shape measurement method for measuring a shape of a surface to be measured in which a plurality of sets of partial measurement data are connected to each other.

### CITATION LIST

### Patent Literature

PTL 1: Japanese Patent No. 6289001

### SUMMARY OF THE INVENTION

The shape measurement method described in PTL 1 still has room for improvement in terms of improving measurement accuracy.

The present disclosure provides a shape measurement method and a shape measurement device in which measurement accuracy is improved.

A shape measurement method according to an aspect of the present disclosure is configured to measure a three-dimensional shape of a surface of a measurement object, the shape measurement method including the steps of: dividing the surface of the measurement object into a plurality of measurement regions including a first measurement region and a second measurement region that have respective overlapping regions overlapping each other; acquiring a plurality of sets of partial measurement data including first partial measurement data acquired by measuring three-dimensional coordinates at each of a plurality of measurement points in the first measurement region and second partial measurement data acquired by measuring three-dimensional coordinates at each of a plurality of measurement points in the second measurement region; calculating a first coordinate transformation parameter for performing global alignment of the plurality of sets of partial measurement data by comparing the three-dimensional coordinates included in the plurality of sets of partial measurement data with reference coordinates calculated by a reference equation indicating a shape of a surface of the measurement object to cause a difference between the three-dimensional coordinates of the plurality of sets of partial measurement data and the reference coordinates to be smaller than a predetermined first threshold value; acquiring error calculation data including a normal line at each of the plurality of measurement points of the plurality of sets of partial measurement data; extracting the overlapping regions based on the plurality of sets of partial measurement data and the first coordinate transformation parameter; calculating a second coordinate transformation parameter for performing local alignment of the plurality of sets of partial measurement data based on the error calculation data to cause a difference calculated based on the three-dimensional coordinates and the normal line at each of the plurality of measurement points in the first partial measurement data, and the three-dimensional coordinates and the normal line at each of the plurality of measurement points in the second partial measurement data in the extracted overlapping regions to be smaller than a predetermined second threshold value; and generating composite data acquired by combining the plurality of sets of partial measurement data based on the first coordinate transformation parameter and the second coordinate transformation parameter.

A shape measurement device according to an aspect of the present disclosure is configured to measure a three-dimensional shape of a surface of a measurement object, the shape measurement device including: one or more processors; and a memory storing commands to be executed by the one or more processors, and the commands including the steps to be implemented in the shape measurement method described above.

The present disclosure enables providing a shape measurement method and a shape measurement device in which measurement accuracy is improved.

### BRIEF DESCRIPTION OF THE DRAWINGS

FIG. 1 is a block diagram schematically illustrating a shape measurement device according to a first exemplary embodiment of the present disclosure.

FIG. 2 is a flowchart illustrating a shape measurement method according to the first exemplary embodiment of the present disclosure.

FIG. 3A is a side view illustrating a measurement object in FIG. 1.

FIG. 3B is a top view illustrating the measurement object in FIG. 1.

FIG. 4A is a diagram for illustrating an overlapping region.

FIG. 4B is a diagram for illustrating an overlapping region.

FIG. 5 is a diagram illustrating an example of a plurality of measurement points in a measurement region.

FIG. 6 is a diagram illustrating an example of partial measurement data on each measurement region.

FIG. 7 is a flowchart for illustrating a method for calculating a first coordinate transformation parameter.

FIG. 8 is a flowchart for illustrating a method for calculating a second coordinate transformation parameter.

FIG. 9 is a schematic view illustrating a measurement point and a normal line included in an overlapping region of a first measurement region and a second measurement region.

FIG. 10A is a diagram illustrating measurement data acquired by combining a plurality of sets of partial measurement data using a first coordinate transformation parameter.

FIG. 10B is a diagram illustrating measurement data acquired by combining a plurality of sets of partial measurement data using the first coordinate transformation parameter and the second coordinate transformation parameter.

FIG. 10C is a diagram illustrating measurement data acquired by measuring a shape of a surface of a measurement object without dividing the object into a plurality of measurement regions.

FIG. 11A is a graph illustrating a magnitude of an error of the measurement data illustrated in FIG. 10A.

FIG. 11B is a graph illustrating a magnitude of an error of the measurement data illustrated in FIG. 10B.

FIG. 11C is a graph illustrating a magnitude of an error of the measurement data illustrated in FIG. 10C.

FIG. 12 is a diagram illustrating an example of a measurement object in a shape measurement method according to a second exemplary embodiment.

FIG. 13A is a side view illustrating the measurement object in FIG. 12.

FIG. 13B is a top view illustrating the measurement object in FIG. 12.

FIG. 14 is a diagram illustrating an example of partial measurement data on each measurement region.

FIG. 15 is a diagram illustrating measurement data acquired by combining the measurement data of FIG. 14.

### DESCRIPTION OF EMBODIMENT

### Background to Present Disclosure

Three-dimensional measuring machines used for measuring a three-dimensional shape of an optical component have a determined range of measurable size and an inclination angle. In many cases, a three-dimensional measuring machine having a measurable range for size and shape of a measurement object is used. Alternatively, the identical three-dimensional measuring machine is also desired to be used for measuring a measurement object having a size and a shape beyond the measurable range, such as a large mirror or a high-inclination lens. In this case, a surface of the measurement object is less likely to be evaluated by one measurement. Thus, a shape of the surface of the measurement object is evaluated based on composite data acquired by combining measurement data acquired by performing measurement multiple times while changing orientation of the measurement object at the time of installation in the three-dimensional measuring machine, for example.

Known techniques for combining a plurality of measurement data include a technique called stitching. Examples of the stitching include a shape measurement method described in PTL 1. The shape measurement method described in PTL 1 is configured to first acquire a plurality of sets of partial measurement data for a surface to be measured and data on a relative inclination between the plurality of sets of partial measurement data. Next, the plurality of sets of partial measurement data is moved in a direction in which the relative inclination decreases, and the plurality of sets of partial measurement data after the movement is acquired. After that, the plurality of sets of partial measurement data after the movement is fitted to reduce a difference in a translation direction and a rotation direction between each of the plurality of sets of partial measurement data after the movement and a common reference equation. The plurality of sets of partial measurement data after the movement having been fitted is connected to each other to measure a shape of the surface to be measured.

The shape measurement method described in PTL 1 has a problem that highly accurate stitching is difficult due to use of the reference equation. The reference equation indicates an ideal shape of the surface of the measurement object shown in a processing drawing. Between the reference equation and the surface shape of the measurement object, a machining error occurs. The machining error is greater than measurement accuracy of the three-dimensional measuring machine in many cases. Thus, only performing alignment with respect to the reference equation may cause a measurement error due to a machining error.

For example, reduction in the measurement error is conceivable in which the reference equation uses a variable coefficient and processing of updating the reference equation is added so that the reference equation approaches to the measurement shape of the measurement object. Unfortunately, this case allows a polynomial with a coefficient that can be updated to be used as the reference equation, but does not allow a piecewise polynomial with a coefficient that cannot be updated to be used as the reference equation.

The shape measurement method described in PTL 1 is also configured to acquire data on an inclination corresponding to each of a plurality of sets of partial measurement data by measuring a reference body at a position fixed with respect to the object to be measured. This case causes not only a problem of increasing measurement time due to acquisition of data on a relative inclination, but also a problem of increase in labor due to attaching of the reference body to the object to be measured.

Thus, the inventors of the present invention have studied a shape measurement method and a shape measurement device capable of solving the problems described above to lead to the invention below.

Hereinafter, exemplary embodiments of the present invention will be described in detail below with reference to the accompanying drawings. However, the present invention is not limited to the exemplary embodiments below. The description below and the accompanying drawings are simplified as appropriate to clarify the description.

### First Exemplary Embodiment

### [General Configuration]

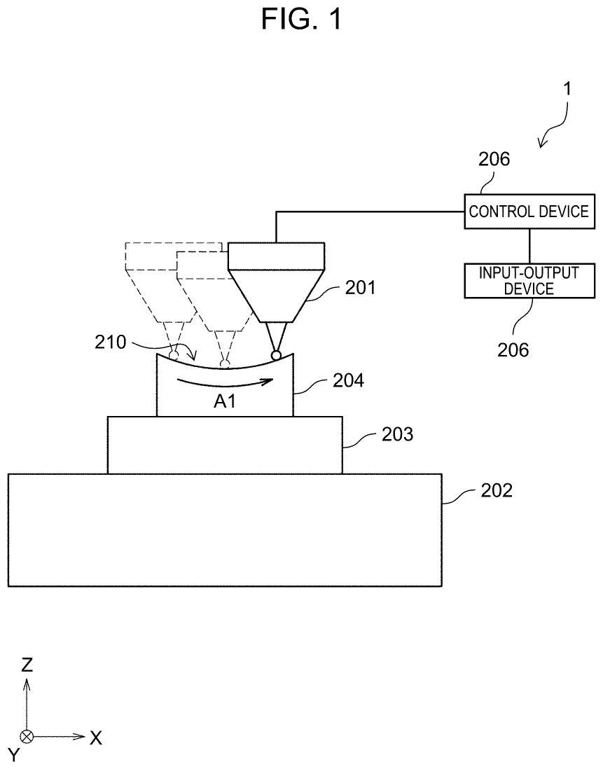

FIG. 1 is a block diagram schematically illustrating shape measurement device 1 according to a first exemplary embodiment of the present disclosure. As illustrated in FIG. 1, shape measurement device 1 includes stage 202 on which measurement object 204 is placed, holding member 203 that holds measurement object 204, probe 201 that scans a surface of measurement object 204, and control device 205 that controls operation of probe 201.

Shape measurement device 1 is a contact-type shape measurement device, and measures a three-dimensional shape of the surface of measurement object 204 by scanning surface 210 of measurement object 204 with probe 201.

Measurement object 204 includes an optical component such as a lens or a mirror, for example. Measurement object 204 is disposed on stage 202 using holding member 203.

Probe 201 and stage 202 are each equipped with a drive device (not illustrated) for movement in an X-axis direction, a Y-axis direction, and a Z-axis direction. Probe 201 comes into contact with measurement object 204 with a constant force at a contact position that is acquired as three-dimensional coordinates of an X-coordinate, a Y-coordinate, and a Z-coordinate. Probe 201 is moved to an XY-coordinate designated by using the drive device, and is moved in the Z-direction along the surface of measurement object 204 at the XY-coordinates after the movement, thereby coming into contact with the surface of measurement object 204. Thus, probe 201 is moved along surface 210 of measurement object 204 as indicated by arrow A1 in FIG. 1. Such operation enables three-dimensional coordinates of surface 210 of measurement object 204 to be measured.

Control device 205 controls movement of probe 201 and acquisition of three-dimensional coordinates. Control device 205 includes a processor including a digital circuit such as a microcomputer, a CPU, an MPU, a GPU, a DSP, an FPGA, or an ASIC, and a memory, for example. The memory records a command to be executed by the processor.

The shape measurement device 1 may include input-output device 206 to issue a measurement start command or display a three-dimensional shape measured. Input-output device 206 includes a keyboard, a mouse, or a display, for example.

### [Operation]

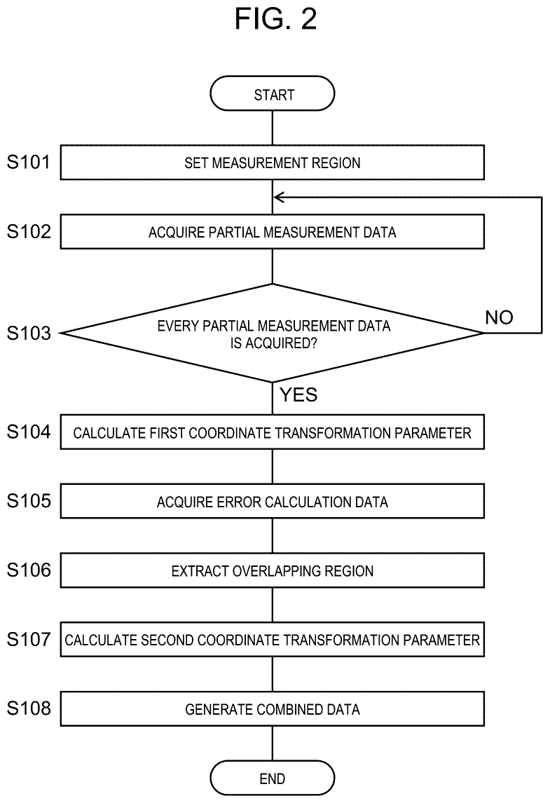

With reference to FIG. 2, a shape measurement method in shape measurement device 1 will be described. FIG. 2 is a flowchart illustrating the shape measurement method according to the first exemplary embodiment of the present disclosure.

First, control device 205 sets a measurement region in step S101. The measurement region indicates each region acquired by dividing the surface of the measurement object 204 into a plurality of regions.

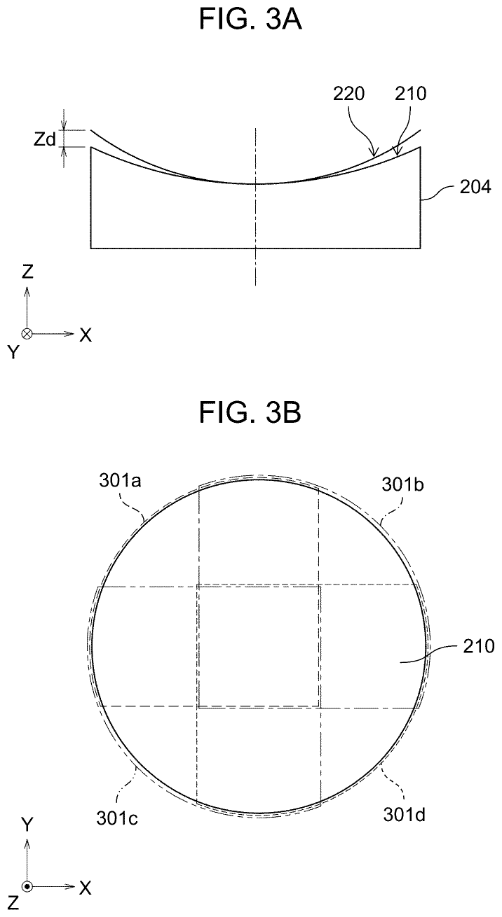

FIG. 3A is a side view illustrating measurement object 204 in FIG. 1. FIG. 3B is a top view illustrating measurement object 204 in FIG. 1. As illustrated in FIG. 3A, surface 210 of measurement object 204 is formed in a concave shape recessed toward the center. As illustrated in FIG. 3B, measurement object 204 has a circular shape when viewed from the Z-direction. That is, surface 210 of measurement object 204 is formed as a rotationally symmetric aspheric curved surface. Surface 210 of measurement object 204 has a design shape represented by Expression (1), for example. Expression (1) is a rotationally symmetric aspheric expression in the form of a matrix variable polynomial. Here, r is a distance from the center of surface 210 of measurement object 204, c is a reciprocal of a curvature radius, k is a conic coefficient, and Aᵢ is a polynomial coefficient.

$$\begin{matrix}[ Expression 1 ] & \\ z ( r ) = \frac{c {r}^{2}}{1 + \sqrt{1 - ( 1 + k ) {c}^{2} {r}^{2}}} + {\sum }_{i = 1}^{20} {A}_{i} {\vert r \vert}^{i} & ( 1 )\end{matrix}$$

Expression (1) defines a curved surface that is curved surface 220 in FIG. 3A, and that indicates an ideal curved surface of measurement target part 204. Surface 210 of measurement object 204 and curved surface 220 indicated by the reference equation are not identical in shape due to machining error Zd having occurred.

In step S101, surface 210 of measurement object 204 is divided into four measurement regions of first measurement region 301a, second measurement region 301b, third measurement region 301c, and fourth measurement region 301d. The number of measurement regions is not limited to four as long as each measurement region has a size and a shape that fall within a measurement range of shape measurement device 1. For example, surface 210 of measurement object 204 may be divided into two or more measurement regions.

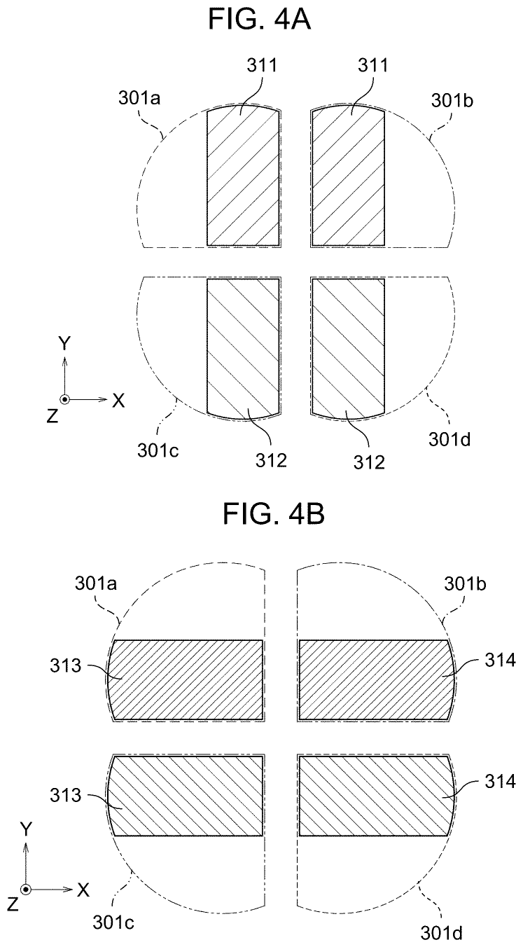

Measurement regions 301a to 301d have corresponding overlapping regions 311 to 314 overlapping each other. FIGS. 4A and 4B are diagrams for illustrating corresponding overlapping regions 311 to 314. As illustrated in FIG. 4A, first measurement region 301a and second measurement region 301b overlap each other in overlapping region 311. Similarly, third measurement region 301c and fourth measurement region 301d overlap each other in overlapping region 312. As illustrated in FIG. 4B, first measurement region 301a and third measurement region 301c overlap each other in overlapping region 313. Similarly, second measurement region 301b and fourth measurement region 301d overlap each other in overlapping region 314. In other words, measurement regions 301a to 301d are set to overlap corresponding adjacent measurement regions 301a to 301d. As overlapping regions 311 to 314 each have a larger area, improvement in combination accuracy is expected when partial measurement data to be described later is combined. Thus, overlapping regions 311 to 314 are set to allow each of measurement regions 301a to 301d to overlap with 50% or more of its area in the present exemplary embodiment. Overlapping regions 311 to 314 are not each limited to this size, and the corresponding adjacent measurement regions 301a to 301d may overlap at least partially.

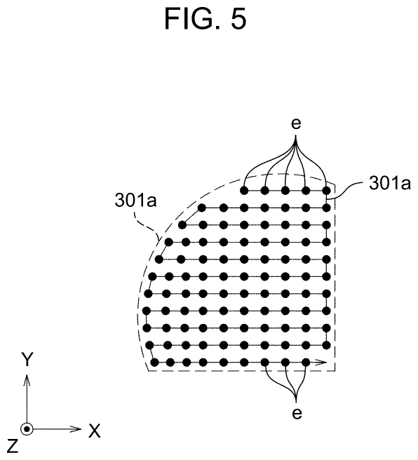

Next, control device 205 causes probe 201 to scan to acquire a plurality of sets of partial measurement data in step S102. The plurality of sets of partial measurement data includes first partial measurement data to fourth partial measurement data acquired for measurement regions 301a to 301d, respectively. For example, for first measurement region 301a, probe 201 scans first measurement region 301a on surface 210 of measurement object 204, and three-dimensional coordinates are measured at a plurality of measurement points e. FIG. 5 is a diagram illustrating an example of the plurality of measurement points e in the measurement region. As illustrated in FIG. 5, probe 201 is moved on surface 210 of measurement object 204 along the X-axis direction and the Y-axis direction in first measurement region 301a to measure Z-coordinates at the plurality of measurement points e, thereby acquiring three-dimensional coordinates at each measurement point “e”, for example. The three-dimensional coordinates at the plurality of measurement points e are collected to acquire the first partial measurement data. Similarly, three-dimensional coordinates at a plurality of measurement points e are acquired for second measurement region 301b to fourth measurement region 301d to acquire the second partial measurement data to the fourth partial measurement data, respectively.

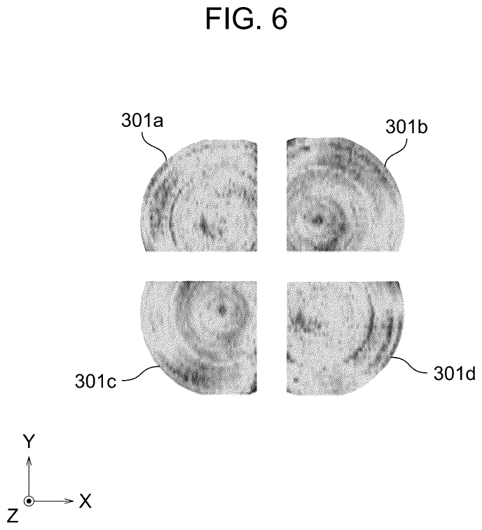

FIG. 6 is a diagram illustrating an example of partial measurement data for each of measurement regions 301a to 301d. The example of FIG. 6 shows that three-dimensional coordinates at each measurement point “e” is displayed in color closer to black as deviation from a value calculated from the reference equation increases, i.e., as machining error Zd illustrated in FIG. 3A increases.

Next, control device 205 determines whether all the partial measurement data have been acquired, in step S103. When all the partial measurement data of the first partial measurement data to the fourth partial measurement data have not been acquired, processing returns to step S102. When all the partial measurement data have been acquired, the processing proceeds to step S104.

Next, control device 205 calculates a first coordinate transformation parameter in step S104. The first coordinate transformation parameter is for performing global alignment of a plurality of sets of partial measurement data, and is calculated using the reference equation indicating surface 210 of measurement object 204. The global alignment of the plurality of sets of partial measurement data indicates that rough alignment of the plurality of sets of partial measurement data is performed to reduce an error between each partial measurement data and the reference equation as much as possible. The first coordinate transformation parameter is calculated for each partial measurement data.

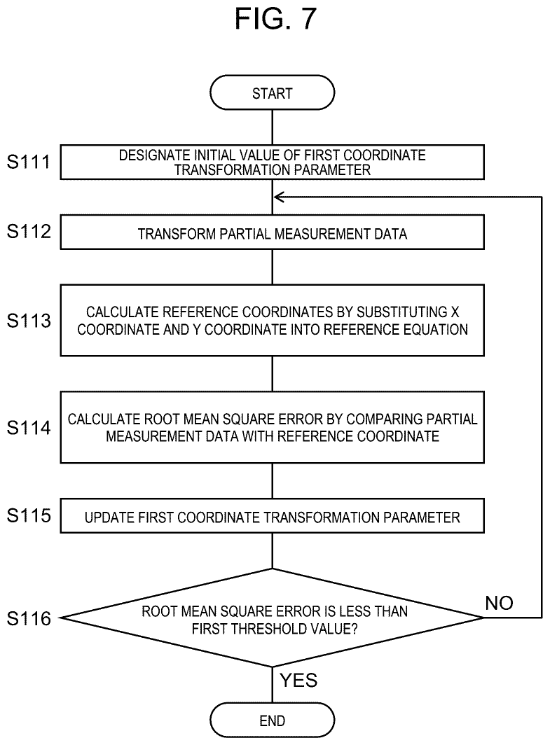

With reference to FIG. 7, specific processing contents for the calculation of the first coordinate transformation parameter will be described using the first partial measurement data, for example. FIG. 7 is a flowchart for illustrating a method for calculating the first coordinate transformation parameter.

First, an initial value of the first coordinate transformation parameter is set in step S111. As the initial value of the first coordinate transformation parameter, a predetermined value may be used, or an arbitrary value may be used.

Next, coordinates of each partial measurement data are transformed using the initial value of the first coordinate transformation parameter in step S112.

Subsequently, values of the X-coordinate and the Y-coordinate of each of the three-dimensional coordinates p₁₁ to p₁ₙ included in the transformed partial measurement data (first partial measurement data) P1 (p₁₁, p₁₂, . . . , pin) are substituted into the reference equation shown in Expression (1) in step S113. The X-coordinate and the Y-coordinate of each of the three-dimensional coordinates p₁₁ to p₁ₙ are substituted into the reference equation to calculate a reference coordinate for each measurement point. The reference coordinate indicates a point on curved surface 220 indicated by the reference equation.

Next, the three-dimensional coordinates at each measurement point “e” of first partial measurement data P1 is compared with the three-dimensional coordinates of each reference coordinate in step S114. More specifically, the Z-coordinate at each measurement point “e” of first partial measurement data P1 is compared with the Z-coordinate of each reference coordinate to acquire a difference, and a root mean square error (RMSE) of the difference is calculated. The root mean square error indicates the difference between the Z-coordinate and the reference coordinate at each measurement point.

Subsequently, the first coordinate transformation parameter is updated to minimize a difference between the three-dimensional coordinates and the three-dimensional coordinates of the reference coordinate at each measurement point in step S115.

Next, it is determined whether the root mean square error calculated in step S114 is smaller than a predetermined first threshold value in step S116. When the root mean square error calculated in step S114 is smaller than the predetermined first threshold value, the processing ends. When the root mean square error calculated in step S114 is larger than the predetermined first threshold value, the processing in steps S112 to S115 is repeated. When the root mean square error falls below the predetermined first threshold value or converges to a predetermined value and does not change as a result of iterative calculation of the first coordinate transformation parameter, the iterative calculation is terminated to determine the first coordinate transformation parameter. When a newly calculated value of the root mean square error increases from a previous calculation result, it may be determined that the root mean square error has converged.

First coordinate transformation parameters are similarly calculated for second partial measurement data P2 (P₂₁, P₂₂, . . . , P₂ₙ), third partial measurement data P3 (P₃₁, P₃₂, . . . , P₃ₙ), and fourth partial measurement data P4 (P₄₁, P₄₂, . . . , P₄ₙ).

Returning to FIG. 2, after the first coordinate transformation parameters are calculated, control device 205 acquires error calculation data in step S105. The error calculation data includes a normal line at each measurement point “e” included in each partial measurement data. The normal line can be acquired as follows: a plane is specified by the method of least squares using a certain measurement point “e” and a plurality of measurement points near the measurement point; and a direction perpendicular to the specified plane is acquired as the normal line, for example. Alternatively, the normal line may be acquired using a reference equation, for example.

Next, control device 205 extracts overlapping regions 311 to 314 in step S106. Overlapping regions 311 to 314 are extracted based on corresponding partial measurement data P1 to P4 and the first coordinate transformation parameter. Specifically, partial measurement data P1 to P4 are transformed using the first coordinate transformation parameter, and partial measurement data P1 to P4 transformed are projected on an XY-plane. Then, overlapping regions 311 to 314 can be extracted by calculating a convex hull or a concave hull of partial measurement data P1 to P4 projected and using a tolerance calculation of a polygon. Besides this method, overlapping regions 311 to 314 may be extracted by calculation in advance using a measurement region and a reference equation.

Subsequently, control device 205 calculates a second coordinate transformation parameter in step S107. The second coordinate transformation parameter is for performing local alignment of a plurality of sets of partial measurement data, and is calculated based on the error calculation data calculated in step S105. The local alignment of the plurality of sets of partial measurement data indicates that coordinates of the plurality of sets of partial measurement data are transformed and the plurality of sets of partial measurement data is combined. The second coordinate transformation parameter is calculated for each partial measurement data. The second coordinate transformation parameter is calculated based on a normal line at each measurement point “e” included in overlapping regions 311 to 314 of corresponding measurement regions 301a to 301d.

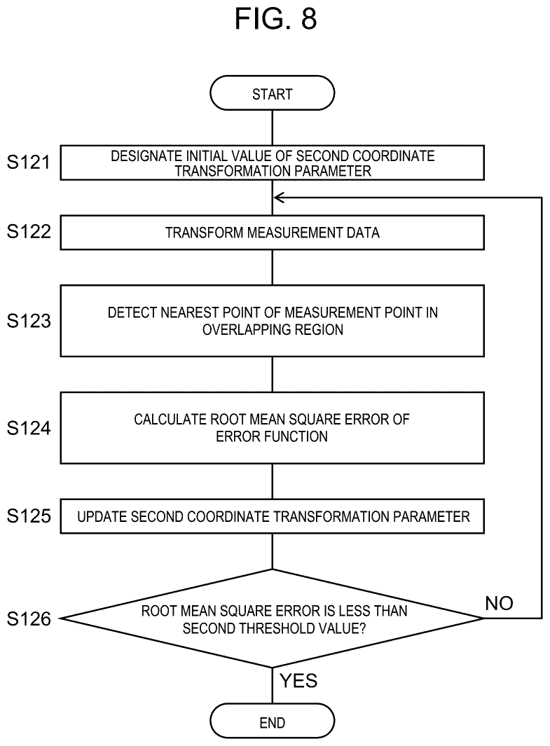

With reference to FIG. 8, specific processing contents for the calculation of the second coordinate transformation parameter will be described. FIG. 8 is a flowchart for illustrating a method for calculating the second coordinate transformation parameter. Here, overlapping region 311 between first measurement region 301a and second measurement region 301b will be described.

First, an initial value of the second coordinate transformation parameter is set in step S121. As the initial value of the second coordinate transformation parameter, a predetermined value may be used, or an arbitrary value may be used.

Next, coordinates of first partial measurement data P1 and second partial measurement data P2 are transformed in step S122, using the initial value of the first coordinate transformation parameter calculated in step S104 and the initial value of the second coordinate transformation parameter set in step S121.

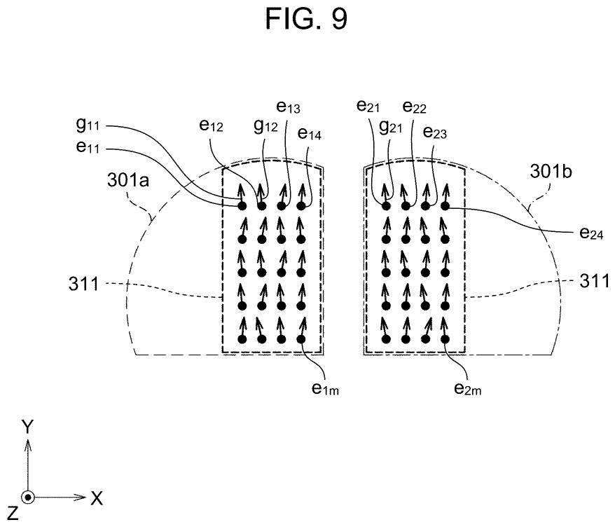

Subsequently, a nearest point of the measurement points included in each overlapping region is detected in step S123. The nearest point indicates a combination of a measurement point in first measurement region 301a and a measurement point in second measurement region 301b, the combination being smallest in distance in overlapping region 311. With reference to FIG. 9, a specific example of detecting the nearest point will be described. FIG. 9 is a schematic view illustrating a measurement point and a normal line included in overlapping region 311 of first measurement region 301a and second measurement region 301b.

For example, three-dimensional coordinates p₁₁ at measurement point e₁₁ included in overlapping region 311 of first measurement region 301a are compared with three-dimensional coordinates p₂₁ to p₂ₘ at the plurality of measurement points e₂₁ to e₂ₘ, respectively, included in overlapping region 311 of second measurement region 301b. As described above, measurement point e₂₁ in second measurement region 301b closest to the coordinates at measurement point e₁₁ in first measurement region 301a is detected among the plurality of measurement points e₂₁ to e₂ₘ included in the overlapping region of second measurement region 301b. In step S123, a closest measurement point in second measurement region 301b is detected for each of measurement points e₁₁ to elm included in overlapping region 311 of first measurement region 301a. The number of measurement points included in overlapping region 311 of first measurement region 301a may not be identical to the number of measurement points included in overlapping region 311 of second measurement region 301b, so that the nearest point may not be detected for every measurement point.

Next, a root mean square error of an error function is calculated in step S124. In step S124, a difference between two measurement points to be nearest, such as measurement point e₁₁ and measurement point e₂₁, is calculated using the error function. The difference is calculated using error calculation data acquired in step S105, for example. For example, the difference can be calculated by the root mean square error of the error function shown in Expression (2) based on the three-dimensional coordinates and three-dimensional normal vector g₁₁ at measurement point e₁₁ included in overlapping region 311 of first measurement region 301a, and the three-dimensional coordinates and three-dimensional normal vector g₂₁ at measurement point e₂₁ included in overlapping region 311 of second measurement region 301b.

$$\begin{matrix}[ Expression 2 ] & \\ ( {p}_{11} - {p}_{21} ) \cdot ( {g}_{11} + {g}_{21} ) & ( 2 )\end{matrix}$$

Next, the second coordinate transformation parameter is updated to minimize the root mean square error of the error function in step S125.

Subsequently, it is determined whether the root mean square error of the error function calculated in step S124 is smaller than a predetermined second threshold value in step S126. When the root mean square error of the error function calculated in step S124 is smaller than the predetermined second threshold value, the processing ends. When the root mean square error of the error function calculated in step S124 is larger than the predetermined second threshold value, the processing in steps S122 to S125 is repeated. When the root mean square error of the error function falls below the predetermined second threshold value or converges to a predetermined value and does not change as a result of iterative calculation of the second coordinate transformation parameter, the iterative calculation is terminated to determine the second coordinate transformation parameter. When a newly calculated value of the root mean square error of the error function increases from a previous calculation result, it may be determined that the root mean square error has converged.

The second coordinate transformation parameter is similarly calculated for overlapping region 312 between third measurement region 301c and fourth measurement region 301d, overlapping region 313 between first measurement region 301a and third measurement region 301c, and overlapping region 314 between second measurement region 301b and fourth measurement region 301d.

Returning to FIG. 2, composite data acquired by combining a plurality of sets of partial measurement data is generated based on the first coordinate transformation parameter and the second coordinate transformation parameter in step S108. The composite data can be generated by transforming coordinates at respective measurement points of the plurality of sets of partial measurement data using the first coordinate transformation parameter and the second coordinate transformation parameter.

### EXAMPLES

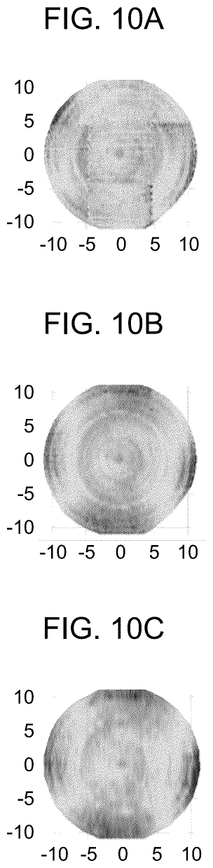

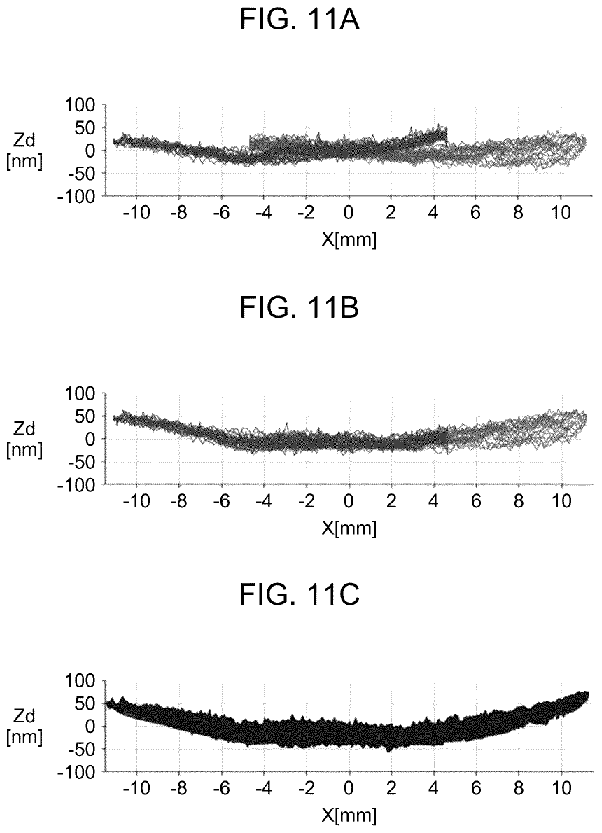

FIG. 10A is a diagram illustrating measurement data acquired by combining a plurality of sets of partial measurement data using the first coordinate transformation parameter. FIG. 10B is a diagram illustrating measurement data acquired by combining a plurality of sets of partial measurement data using the first coordinate transformation parameter and the second coordinate transformation parameter. FIG. 10C is a diagram illustrating measurement data acquired by measuring a shape of a surface of a measurement object without dividing the object into a plurality of measurement regions. FIG. 11A is a graph illustrating a magnitude of an error of the measurement data illustrated in FIG. 10A. FIG. 11B is a graph illustrating a magnitude of an error of the measurement data illustrated in FIG. 10B. FIG. 11C is a graph illustrating a magnitude of an error of the measurement data illustrated in FIG. 10C. FIGS. 10A to 10C each illustrate the measurement data in color closer to black as the measurement data is further away from the value of the reference equation, i.e., as an absolute value of machining error Zd illustrated in FIG. 2 increases. FIGS. 10B and 11B each illustrate the measurement data that is an example using the shape measurement method of the present exemplary embodiment, and FIGS. 10A and 11A each illustrate the data that is a comparative example. FIGS. 10C and 11C each illustrate the data that is acquired by measuring the surface of the measurement object without dividing the surface, and that is a reference example for comparison.

The measurement data in the example is acquired by dividing measurement object 204 illustrated in FIGS. 3A and 3B into four measurement regions 301a to 301d to acquire four sets of partial measurement data, and combining the four sets of partial measurement data using the first coordinate transformation parameter and the second coordinate transformation parameter. The measurement data in the comparative example is acquired by dividing measurement object 204 illustrated in FIGS. 3A and 3B into four measurement regions 301a to 301d to acquire four sets of partial measurement data, and combining the four sets of partial measurement data using only the first coordinate transformation parameter. The measurement data in the reference example is acquired by one measurement without dividing measurement object 204 into a plurality of measurement regions. Measurement object 204 is formed in a circular shape having a diameter of 24 mm when viewed from the Z-direction as illustrated in FIG. 3B, and includes surface 210 in a curved surface expressed by a rotationally symmetric aspheric expression of Expression (1). Not only the total number of measurement points when the four sets of partial measurement data are acquired by dividing the measurement region into four measurement regions 301a to 301d, but also the number of measurement points of data acquired by one measurement without division is about 4000.

In comparison between the measurement data in FIGS. 10A and 10B, and the measurement data in FIG. 10C acquired without division, the measurement data in the example of FIG. 10B includes dark color parts that are approximately identical in distribution to those in the measurement data in FIG. 10C acquired without division. In contrast, the measurement data in the comparative example of FIG. 10A includes dark color parts that are different in distribution from those in the measurement data in FIG. 10C. Only the global alignment using the first coordinate transformation parameter causes a difference on the order of nanometers in the overlapping region of the combined measurement data due to a machining error of the measurement object, so that the measurement data in the comparative example illustrated in FIG. 10A includes the dark color parts different in distribution. Combining the measurement data using two types of parameters of the first coordinate transformation parameter and the second coordinate transformation parameter as in the present exemplary embodiment reveals that a more accurate measurement result can be acquired.

The graphs of FIGS. 11A to 11C each have a vertical axis representing machining error Zd from the reference equation, and a horizontal axis representing positions in the X-direction. The overlapping region is located between-4 mm and 4 mm in the X-direction. FIG. 11A shows measurement data of the comparative example in which combining the partial measurement data causes a difference in a part of the overlapping region, and thus reveals that the plurality of sets of partial measurement data fails to be accurately combined. As for a magnitude of machining error Zd with respect to the reference equation, FIG. 10A shows machining error Zd at a position of 10 mm in the X-direction, machining error Zd having a value less than 50 nm that is different from that in the data illustrated in FIG. 10C, for example.

In contrast, FIG. 11B shows that measurement data can be combined without an error even in the overlapping region between positions of −4 mm and 4 mm in the X-direction. FIG. 10B shows machining error Zd that indicates a value substantially equal to a measurement value in FIG. 11C throughout the X-direction. These results reveal that combining the plurality of sets of partial measurement data using the first coordinate transformation parameter and the second coordinate transformation parameter enables a three-dimensional shape of the surface of the measurement object to be measured more accurately.

### Effects

The exemplary embodiment described above enables providing a shape measurement method and a shape measurement device in which measurement accuracy is improved. The shape measurement method according to the exemplary embodiment described above is configured to generate composite data using global alignment and local alignment. Thus, even when a surface of a measurement object having a size and a shape beyond a measurement range of the shape measurement device is divided into a plurality of measurement regions and measured, a plurality of sets of partial measurement data can be accurately combined. As a result, a shape can be measured with high accuracy even for a surface of a measurement object having a size and a shape beyond the measurement range of the shape measurement device.

Using the first coordinate transformation parameter for performing global alignment and the second coordinate transformation parameter for performing local alignment does not require a mark such as a reference body to be disposed on the measurement object. For this reason, even when a plurality of divided regions is measured, labor during measurement can be reduced to enable the measurement to be easily performed in a short time.

The measurement object has a surface shape that is rotationally symmetric with respect to the Z-axis in the exemplary embodiment described above, so that the amount of movement along each of the X-axis, the Y-axis, and the Z-axis, and the amount of rotation about each of the X-axis and the Y-axis are each calculated as the first coordinate transformation parameter, but the present invention is not limited thereto. When the measurement object has a surface shape that is rotationally symmetric with respect to the Z-axis, for example, there is no orientation uniquely determined about the Z-axis of a plurality of measurement data. Thus, the amount of rotation about the X-axis and the Y-axis is only required to be calculated. The first coordinate transformation parameter may be acquired by calculating the amount of every movement and the amount of every rotation, or acquired without calculating the amount of arbitrary rotation. More specifically, when the measurement object has a spherical shape, only the amount of movement along the X-axis, the Y-axis, and the Z-axis may be calculated as the first coordinate transformation parameter, and the amount of rotation may be fixed at an initial value.

Although an example is described in which the normal line at the measurement point is acquired as the error calculation data in the exemplary embodiment described above, the present invention is not limited thereto. The error calculation data may be information on color of the surface of the measurement object or information on material of the surface of the measurement object, for example. Using the information on color or the information on material enables partial measurement data to be combined more accurately.

For example, a normal line at each measurement point may be acquired as the error calculation data, and brightness at each measurement point may be acquired as the information on color, for example. In the case of measurement point en and measurement point e₂₁ closest to measurement point e₁₁ described in the exemplary embodiment described above, the error function is represented by Expression (3) where luminance at measurement point e₁₁ is denoted by b₁₁ and luminance at measurement point e₂₁ is denoted by b₂₁. Expression (3) shows “σ” indicating a weighting coefficient.

$$\begin{matrix}[ Expression 3 ] & \\ ( {p}_{11} - {p}_{21} ) \cdot ( {g}_{11} + {g}_{21} ) + σ \vert {b}_{11} - {b}_{21} \vert & ( 3 )\end{matrix}$$

### Second Exemplary Embodiment

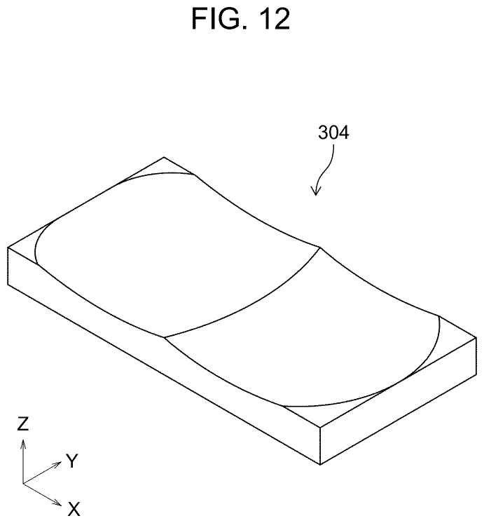

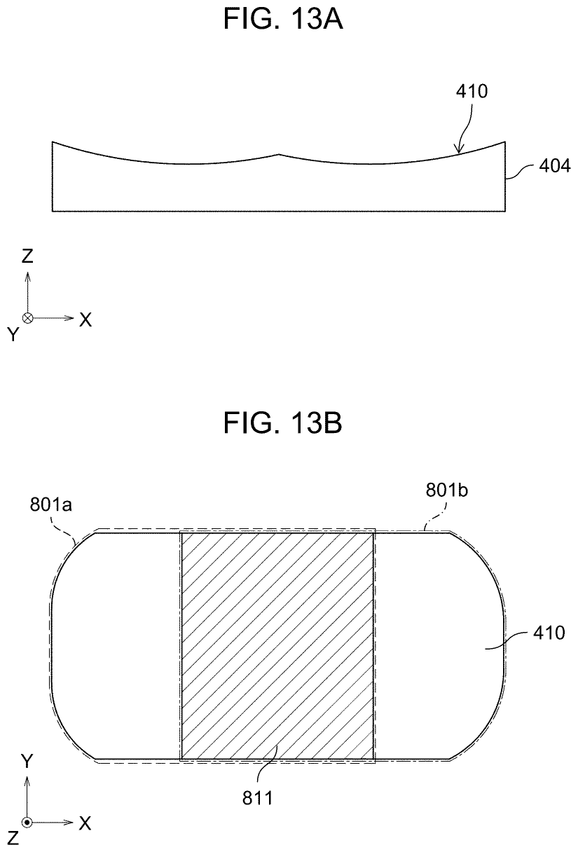

With reference to FIGS. 12 to 13B, a second exemplary embodiment will be described. The second exemplary embodiment includes components identical or equivalent to those in the first exemplary embodiment, the components being denoted by the same reference marks as those in the first exemplary embodiment. The second exemplary embodiment does not duplicate the description in the first exemplary embodiment.

FIG. 12 is a diagram illustrating an example of measurement object 404 in a shape measurement method according to the second exemplary embodiment. FIG. 13A is a side view illustrating measurement object 404 in FIG. 12. FIG. 13B is a top view illustrating measurement object 404 in FIG. 12. As illustrated in FIGS. 12 to 13B, the second exemplary embodiment is different from the first exemplary embodiment in shape of surface 410 of measurement object 404 and in number of measurement regions.

As illustrated in FIGS. 12 and 13A, surface 410 of measurement object 404 includes two curved surfaces. Thus, the reference equation representing surface 410 is expressed using a spline function that is a piecewise polynomial. The spline function representing the reference equation for the surface 410 is expressed by Expression (4) in region Rᵢⱼ in relationships: xᵢ₋₁<x<xᵢ; and yᵢ₋₁<y<yⱼ. Expression (4) shows “x” and “y” that represent an X-coordinate and a Y-coordinate, respectively, and τijₘₙ that is a spline function coefficient.

$$\begin{matrix}[ Expression 4 ] & \\ {z}_{ij} ( x , y ) = {\sum }_{m = 1}^{4} {\sum }_{n = 1}^{4} Γ {{ij}_{mn} ( x - {x}_{i - 1} )}^{m} {( y - {y}_{j - 1} )}^{n} & ( 4 )\end{matrix}$$

As illustrated in FIG. 13B, surface 410 of measurement object 404 is divided into two regions of first measurement region 801a and second measurement region 801b in the present exemplary embodiment. Each of measurement regions 801a and 801b includes overlapping region 811.

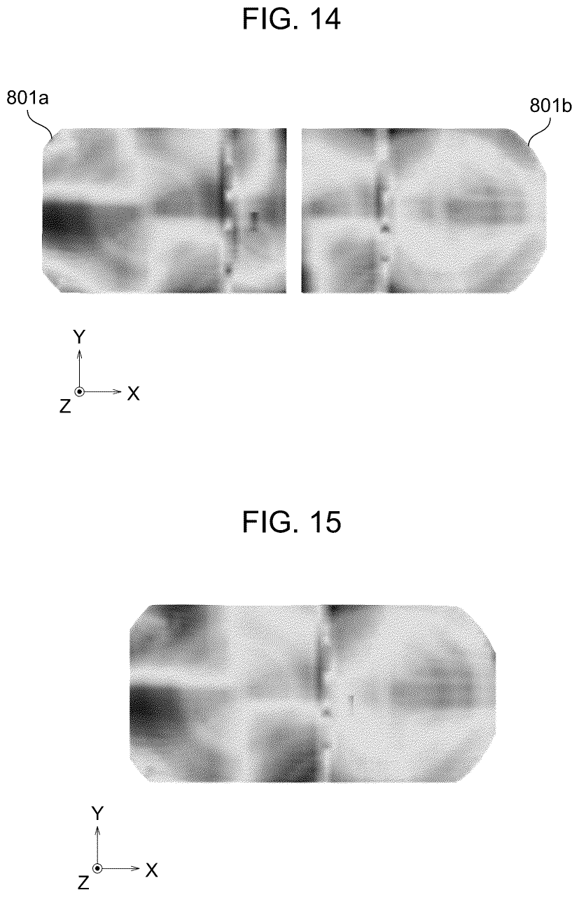

FIG. 14 is a diagram illustrating an example of partial measurement data for each of measurement regions 801a and 801b. FIG. 15 is a diagram illustrating measurement data obtained by combining the measurement data of FIG. 14. As in the first exemplary embodiment, when the two sets of partial measurement data illustrated in FIG. 14 are combined, measurement data can be obtained throughout surface 410 of measurement object 404 illustrated in FIG. 15. The measurement data of FIG. 15 reveals that measurement data can be combined with high accuracy even in the reference equation including the piecewise polynomial because a shade showing unnatural undulations is not seen in the overlapping region.

### Effects

The exemplary embodiments described above enables a shape of surface 410 of measurement object 404 to be accurately measured even when a reference equation includes a piecewise polynomial.

Although an example of dividing a measurement region into a plurality of measurement regions on the XY-plane has been described in the exemplary embodiments described above, the present invention is not limited the example. For example, a measurement object having a size exceeding a measurement range of the shape measurement device in the Z-direction may be measured using measurement regions divided in the Z-direction.

### Overview of Exemplary Embodiments

(1) A shape measurement method according to the present disclosure is configured to measure a three-dimensional shape of a surface of a measurement object, the shape measurement method including the steps of: dividing the surface of the measurement object into a plurality of measurement regions including a first measurement region and a second measurement region that have respective overlapping regions overlapping each other; acquiring a plurality of sets of partial measurement data including first partial measurement data obtained by measuring three-dimensional coordinates at each of a plurality of measurement points in the first measurement region and second partial measurement data obtained by measuring three-dimensional coordinates at each of a plurality of measurement points in the second measurement region; calculating a first coordinate transformation parameter for performing global alignment of the plurality of sets of partial measurement data by comparing the three-dimensional coordinates included in the plurality of sets of partial measurement data with reference coordinates calculated by a reference equation indicating a shape of a surface of the measurement object to cause a difference between the three-dimensional coordinates of the plurality of sets of partial measurement data and the reference coordinates to be smaller than a predetermined first threshold value; acquiring error calculation data including a normal line at each of the plurality of measurement points of the plurality of sets of partial measurement data; extracting the overlapping regions based on the plurality of sets of partial measurement data and the first coordinate transformation parameter; calculating a second coordinate transformation parameter for performing local alignment of the plurality of sets of partial measurement data based on the error calculation data to cause a difference calculated based on the three-dimensional coordinates and the normal line at each of the plurality of measurement points in the first partial measurement data, and the three-dimensional coordinates and the normal line at each of the plurality of measurement points in the second partial measurement data in the extracted overlapping regions to be smaller than a predetermined second threshold value; and generating composite data obtained by combining the plurality of sets of partial measurement data based on the first coordinate transformation parameter and the second coordinate transformation parameter.

(2) The shape measurement method of item (1) may be configured such that the step of calculating the first coordinate transformation parameter includes calculating the first coordinate transformation parameter by fixing amounts of rotation of the plurality of sets of partial measurement data with respect to the reference equation.

(3) The shape measurement method of item (1) or (2) may be configured such that the error calculation data includes color information on the surface of the measurement object or material information on the surface of the measurement object, and the step of calculating the second coordinate transformation parameter includes calculating the second coordinate transformation parameter based on the color information or the material information.

(4) The shape measurement method of any one of items (1) to (3) may be configured such that the step of calculating the second coordinate transformation parameter includes calculating the second coordinate transformation parameter using a method of least squares.

(5) The shape measurement method of any one of items (1) to (4) may be configured such that the reference equation includes a matrix variable polynomial.

(6) The shape measurement method of any one of items (1) to (4) may be configured such that the reference equation includes a piecewise polynomial.

(7) A shape measurement device according to the present disclosure is configured to measure a three-dimensional shape of a surface of a measurement object, the shape measurement device including: one or more processors; and a memory storing commands to be executed by the one or more processors, and the commands including the steps to be implemented in the shape measurement method according to any one of items (1) to (6).

### INDUSTRIAL APPLICABILITY

The shape measurement method and the shape measurement device of the present disclosure is capable of accurately measuring a surface of a measurement object having a size or a shape beyond a measurement range of the shape measurement device. Thus, the shape measurement method and the shape measurement device of the present disclosure is capable of evaluating a shape of a large mirror or a high gradient lens with high accuracy, and can be applied to applications of performance improvement by correction processing.

### REFERENCE MARKS IN THE DRAWINGS

1: shape measurement device
201: probe
202: stage
203: holding member
204, 404: measurement object
205: control device
206: input-output device
210, 410: surface
220: curved surface
301a: first measurement region
301b: second measurement region
301c: third measurement region
301d: fourth measurement region
801a: first measurement region
801b: second measurement region
311 to 314, 811: overlapping region

1. A shape measurement method configured to measure a three-dimensional shape of a surface of a measurement object, the shape measurement method comprising the steps of:
dividing the surface of the measurement object into a plurality of measurement regions including a first measurement region and a second measurement region that have respective overlapping regions overlapping each other;
acquiring a plurality of sets of partial measurement data including first partial measurement data acquired by measuring three-dimensional coordinates at each of a plurality of measurement points in the first measurement region and second partial measurement data acquired by measuring three-dimensional coordinates at each of a plurality of measurement points in the second measurement region;
calculating a first coordinate transformation parameter for performing global alignment of the plurality of sets of partial measurement data by comparing the three-dimensional coordinates included in the plurality of sets of partial measurement data with reference coordinates calculated by a reference equation indicating a shape of a surface of the measurement object to cause a difference between the three-dimensional coordinates of the plurality of sets of partial measurement data and the reference coordinates to be smaller than a predetermined first threshold value;
acquiring error calculation data including a normal line at each of the plurality of measurement points of the plurality of sets of partial measurement data;
extracting the overlapping regions based on the plurality of sets of partial measurement data and the first coordinate transformation parameter;
calculating a second coordinate transformation parameter for performing local alignment of the plurality of sets of partial measurement data based on the error calculation data to cause a difference calculated based on the three-dimensional coordinates and the normal line at each of the plurality of measurement points in the first partial measurement data, and the three-dimensional coordinates and the normal line at each of the plurality of measurement points in the second partial measurement data in the extracted overlapping regions to be smaller than a predetermined second threshold value; and
generating composite data acquired by combining the plurality of sets of partial measurement data based on the first coordinate transformation parameter and the second coordinate transformation parameter.

2. The shape measurement method according to claim 1, wherein the step of calculating the first coordinate transformation parameter includes calculating the first coordinate transformation parameter by fixing amounts of rotation of the plurality of sets of partial measurement data with respect to the reference equation.

3. The shape measurement method according to claim 1, wherein
the error calculation data includes color information on the surface of the measurement object or material information on the surface of the measurement object, and
the step of calculating the second coordinate transformation parameter includes calculating the second coordinate transformation parameter based on the color information or the material information.

4. The shape measurement method according to claim 1, wherein the step of calculating the second coordinate transformation parameter includes calculating the second coordinate transformation parameter using a method of least squares.

5. The shape measurement method according to claim 1, wherein the reference equation includes a matrix variable polynomial.

6. The shape measurement method according to claim 1, wherein the reference equation includes a piecewise polynomial.

7. A shape measurement device configured to measure a three-dimensional shape of a surface of a measurement object, the shape measurement device comprising:
one or more processors; and
a memory storing commands to be executed by the one or more processors, and
the commands including the steps to be implemented in the shape measurement method according to claim 1.
